(19) United States
(12) Patent Application Publication
(10) Pub. No.: US 2026/0219396 A1
(43) Pub. Date: Jul. 30, 2026

(54) GLOBAL NAVIGATION SATELLITE SYSTEM (GNSS) RADIO FREQUENCY INTERFERENCE (RFI) DETECTION

(71) Applicant: QUALCOMM Incorporated, San Diego, CA (US)

(72) Inventors: Dong Kyeong LEE, San Jose, CA (US); Yuxiang PENG, San Jose, CA (US)

(21) Appl. No.: 19/041,320

(22) Filed: Jan. 30, 2025

(51) Int. Cl. G01S 19/21; G01S 19/37

(52) U.S. Cl. CPC G01S 19/21; G01S 19/37

(57) ABSTRACT

In some implementations, a global navigation satellite system (GNSS) device may detect radio frequency interference (RFI) at least in part by determining a plurality of automatic gain control (AGC) measurement sets that include, for each of a plurality of orientations of the GNSS device, a respective AGC measurement set of AGC measurements of one or more GNSS signals received with at least one antenna of the GNSS device while the GNSS device was in the respective orientation. In addition, GNSS device may determine a correlation value indicative of a correlation between: values of the AGC measurements of different AGC measurement sets, and an antenna gain pattern of the at least one antenna of the GNSS device. The GNSS device may output an indication that RFI has been detected based at least in part on a determination that the correlation value satisfies a correlation threshold.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. Radio frequency interference (RFI) can reduce the accuracy, integrity, and reliability of GNSS positioning, reducing the value of these positioning-based applications and potentially raising safety concerns.

### BRIEF SUMMARY

Embodiments described herein are generally directed toward detecting RFI in a GNSS band based on automatic gain control (AGC) values and antenna gain pattern related to one or more antennas used by a GNSS device to receive GNSS signals in the GNSS band. In particular, because AGC values obtained while the GNSS device is in different orientations may more strongly correlate with the antenna gain pattern in the presence of RFI, the GNSS device may detect this RFI using this correlation. Moreover, according to some embodiments, carrier-to-noise power density (C/No) values may also be used in the determination of whether RFI is present.

An example method of radio frequency interference (RFI) detection by a global navigation satellite system (GNSS) device, according to this disclosure, comprises: determining a plurality of automatic gain control (AGC) measurement sets, wherein the plurality of AGC measurement sets comprises, for each respective orientation of a plurality of orientations of the GNSS device, a respective AGC measurement set of one or more automatic gain control (AGC) measurements of one or more GNSS signals received with at least one antenna of the GNSS device while the GNSS device was in the respective orientation. The method further comprises determining a correlation value indicative of a correlation between: values of the one or more AGC measurements of different AGC measurement sets of the plurality of AGC measurement sets, and an antenna gain pattern of the at least one antenna of the GNSS device. The method further comprises outputting an indication that RFI has been detected based at least in part on a determination that the correlation value satisfies a correlation threshold.

An example global navigation satellite system global navigation satellite system (GNSS) device, according to this disclosure, comprises: at least one antenna, at least one GNSS receiver, and at least one processor communicatively coupled with the at least one antenna and at least one GNSS receiver, the at least one processor configured to: determine a plurality of automatic gain control (AGC) measurement sets, wherein the plurality of AGC measurement sets comprises, for each respective orientation of a plurality of orientations of the GNSS device, a respective AGC measurement set of one or more automatic gain control (AGC) measurements of one or more GNSS signals received with at least one antenna of the GNSS device while the GNSS device was in the respective orientation. The at least one processor is further configured to determine a correlation value indicative of a correlation between: values of the one or more AGC measurements of different AGC measurement sets of the plurality of AGC measurement sets, and an antenna gain pattern of the at least one antenna of the GNSS device. The at least one processor is further configured to output an indication that radio frequency interference (RFI) has been detected based at least in part on a determination that the correlation value satisfies a correlation threshold.

An apparatus, according to this disclosure, comprises means for determining a plurality of automatic gain control (AGC) measurement sets, wherein the plurality of AGC measurement sets comprises, for each respective orientation of a plurality of orientations of the apparatus, a respective AGC measurement set of one or more automatic gain control (AGC) measurements of one or more global navigation satellite system global navigation satellite system (GNSS) signals received with at least one antenna of the apparatus while the apparatus was in the respective orientation. The apparatus further comprises means for determining a correlation value indicative of a correlation between: values of the one or more AGC measurements of different AGC measurement sets of the plurality of AGC measurement sets, and an antenna gain pattern of the at least one antenna of the apparatus. The apparatus further comprises means for outputting an indication that RFI has been detected based at least in part on a determination that the correlation value satisfies a correlation threshold.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of an example global navigation satellite system (GNSS) system.

FIG. 2 is a simplified block diagram of an example signal processing architecture that may be used in a GNSS receiver, according to an embodiment.

FIG. 3 is a graph that plots antenna gain for an example antenna.

FIG. 4 is a skyplot illustrating how GNSS satellites may be spread out spatially from the perspective of a GNSS device, according to an example.

FIG. 5 illustrates graphs showing experimental results in which automatic gain control (AGC) values (in decibels) obtained from a GNSS device are plotted over time.

FIG. 6 is a flow diagram of a method of RFI detection that may be performed by a GNSS device, according to an embodiment.

FIG. 7 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “user equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IOT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, a GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” or “satellite vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

GNSS radio frequency interference (RFI) occurs when one or more RF signals use the same frequency as a GNSS frequency band. Unintentional RFI can be common due to the ubiquity of RF-emitting devices, including electronic devices, such as hard drives, which are not intended to transmit RF signals as part of their functionality. Further, governments and other entities (including nefarious actors) may engage in intentional RFI, such as jamming (e.g., flooding an RF band with noise to make GNSS signals unusable) or spoofing (e.g., transmitting a false GNSS signal), which can be deployed to prevent or alter GNSS functionality. As previously noted, because RFI can interfere with the GNSS functionality of various GNSS devices, RFI detection can be an important way in which a device and/or device user can know when RFI is present and GNSS measurements are obtained from an RF band experiencing RFI, and a resulting GNSS-based position may not be reliable.

Automatic gain control (AGC) in RF devices provides information about signals and noise in the RF band. Therefore, in certain circumstances, AGC values can be used to detect potential RFI. However, when the orientation of the GNSS device changes, AGC values also change due to GNSS signals experiencing different gain due to the antenna gain pattern of the one or more antennas of the GNSS device that are also being reoriented. Therefore, AGC level changes without considering orientation changes may be an unreliable way to detect RFI.

Embodiments address these and other issues by providing techniques for detecting the presence of RFI using a GNSS device, based on a correlation between the changes in AGC values of GNSS signals at different orientations of a GNSS device and the antenna gain pattern of the one or more antennas used to receive the GNSS signals. In some embodiments, carrier-to-noise power density (C/No values may also be used in the determination of whether RFI is present. Details regarding these various techniques are provided in the embodiments described herein.

Particular aspects of the subject matter described in this disclosure can be implemented to realize one or more of the following potential advantages. In some examples, by leveraging the correlation between AGC values and the antenna gain pattern at a GNSS device, the described techniques can enable GNSS devices to more accurately detect RFI. Further, this can be implemented to minimize any impact on processing and/or power resources. These and other advantages will be apparent to a person of ordinary skill in the art in view of the embodiments described below. Various embodiments are provided in detail hereafter following a review of applicable technology.

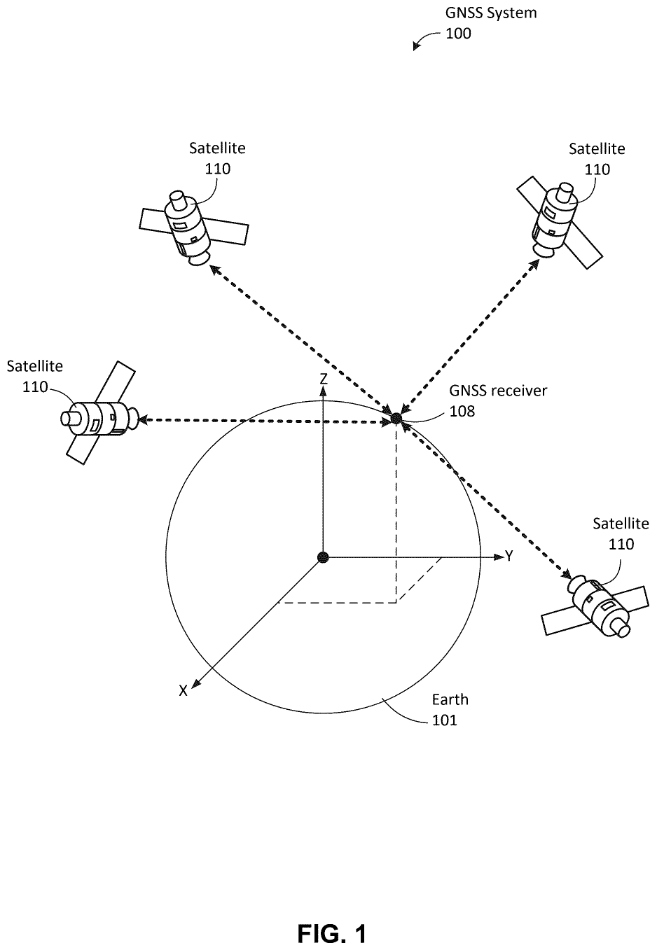

FIG. 1 is a simplified diagram of a GNSS system 100, provided to illustrate how GNSS is generally used to determine an accurate location of a GNSS receiver 108 on earth 101 (also known as “positioning” of the GNSS receiver). Put generally, the GNSS system 100 enables an accurate GNSS position fix of the GNSS receiver 108, which receives RF signals from GNSS satellites (or SVs) 110 from one or more GNSS constellations. The types of GNSS receiver 108 used may vary, depending on the application. In some embodiments, for instance, the GNSS receiver 108 may comprise a standalone device or component incorporated into another device. This can include, for example, consumer electronics or devices, such as a mobile phone, tablet, laptop, wearable device, vehicle (or in-vehicle device), or the like. In some embodiments, the GNSS receiver 108 may be integrated into industrial or commercial equipment, such as survey equipment, Internet of Things (IoT) devices, etc.

It will be understood that the diagram provided in FIG. 1 is greatly simplified. In practice, there may be dozens of satellites 110 in a given GNSS constellation, and many different types of GNSS systems with corresponding constellations. As noted, GNSS systems include global positioning system (GPS), Galileo, Global Navigation Satellite System (GLONASS or GLO), or BeiDou Navigation Satellite System (BDS), Quasi-Zenith Satellite System (QZSS), Indian Regional Navigational Satellite System (IRNSS), etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), BeiDou satellite-based augmentation system (BDSBAS), Geo Augmented Navigation system (GAGAN), and/or the like. SBAS is also described in further detail hereafter.

GNSS positioning is based on trilateration/multilateration, which is a method of determining position by measuring distances to points at known coordinates. In general, determining the position of a GNSS receiver 108 in three dimensions may rely on determining the distance between the GNSS receiver 108 and four or more satellites 110. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 110 and the GNSS receiver 108 may be determined using precise measurements made by the GNSS receiver 108 of a difference in time from when an RF signal is transmitted from the respective satellite 110 to when it is received at the GNSS receiver 108. To help ensure accuracy, not only does the GNSS receiver 108 need to accurately determine when the respective signal from each satellite 110 is received, but many additional factors need to be considered and accounted for. These factors include, for example, clock differences at the GNSS receiver 108 and satellite 110 (e.g., clock bias), a precise location of each satellite 110 at the time of transmission (e.g., as determined by the broadcast ephemeris), the impact of atmospheric distortion (e.g., ionospheric and tropospheric delays), and the like.

To perform a traditional GNSS position fix, the GNSS receiver 108 can use code-based positioning to determine its distance to each satellite 110 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 110, the GNSS receiver 108 can then determine a position fix for its location. For example, this position fix may be determined by a Standalone Positioning Engine (SPE) executed by one or more processors of the GNSS receiver 108. However, code-based positioning is relatively inaccurate and, without error correction, and is subject to many of the previously described errors. Even so, code-based GNSS positioning can provide a positioning accuracy for the GNSS receiver 108 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 110 observed by the GNSS receiver 108 can be mitigated or canceled based on similar carrier-based ranging of the satellites 110 using a highly accurate GNSS receiver at the base station at a known location. These measurements and the base station's location can be provided to the GNSS receiver 108 for error correction. This position fix may be determined, for example, by a Precise Positioning Engine (PPE) executed by one or more processors of the GNSS receiver 108. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 110 may be members of a single satellite constellation, i.e., a group of satellites that are part of a GNSS system, e.g., controlled by a common entity such as a government, and orbiting in complementary orbits to facilitate determining positions of entities around the world. One or more of the satellites 110 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites; the X-band, used by the military and for RADAR applications; and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

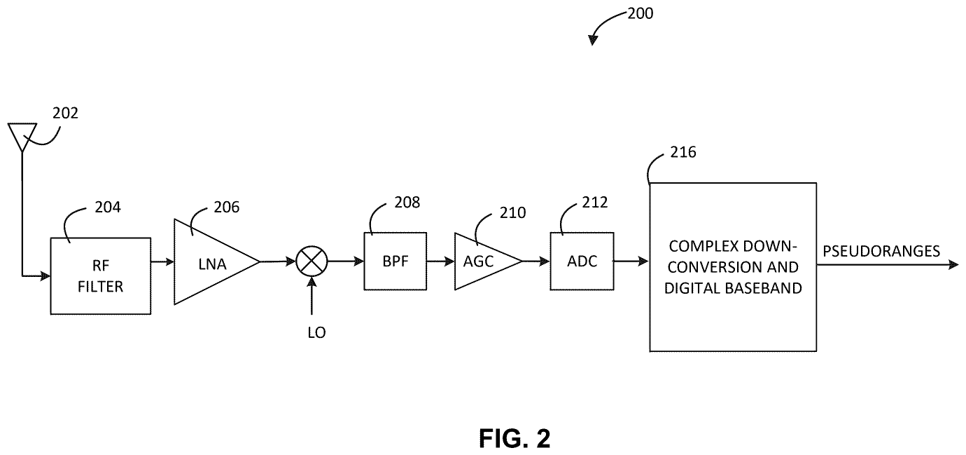

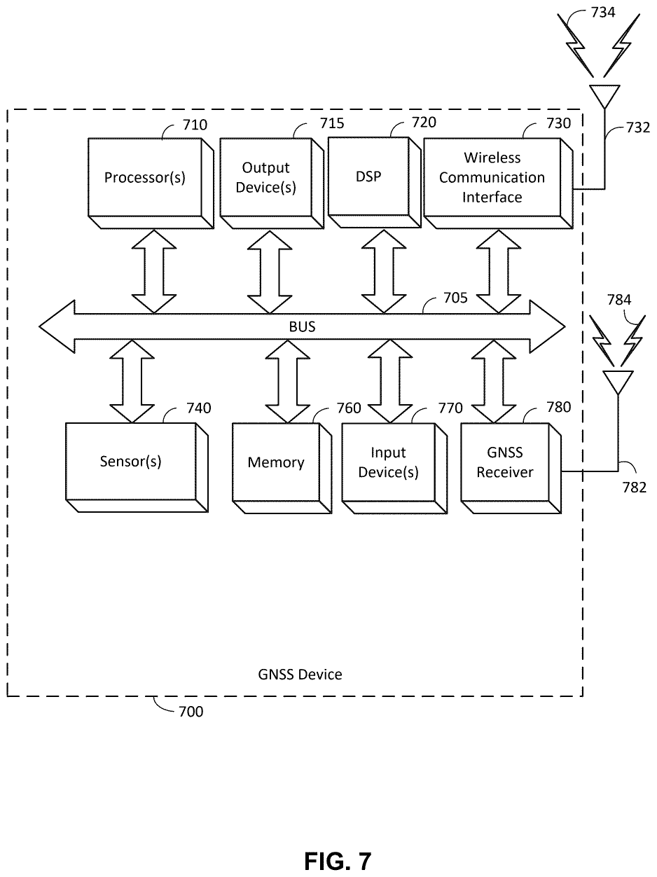

FIG. 2 illustrates a simplified block diagram of an example signal processing architecture 200 that may be used in a GNSS receiver (e.g., GNSS receiver 108 of FIG. 1) to measure GNSS signals and determine pseudoranges (range measurements) for GNSS-based positioning. This signal processing architecture 200 may be implemented in hardware and/or software components of a GNSS device, such as the GNSS receiver 780 of the GNSS device 700 shown in FIG. 7, which is described in more detail hereafter. It should be noted that the example signal processing architecture 200 illustrates a single RF chain, however multiple RF chains may be used to process multiple GNSS signals (e.g., at different bands). As a person of ordinary skill in the art will appreciate, some RF chains may use common components (e.g., such as antenna 202). It will also be appreciated that the architecture 200 is a simplified version of a real-world implementation and provided here to help illustrate the functionality of various components shown. Embodiments are not limited to the architecture 200 shown in FIG. 2; alternative embodiments may include additional or alternative components and/or may rearrange, omit, and/or substitute components, depending on desired functionality.

The signal processing architecture 200 may process GNSS signals as follows. GNSS signals are received at an RF antenna 202 and initially processed by a bandpass RF filter 204 (e.g., a surface acoustic wave (SAW) filter) and a low noise amplifier 206. The received GNSS signals may then be down-converted to intermediate frequencies by mixing the received signals with the LO signal as shown. After down-conversion, signals are then passed through a bandpass filter (BPF) 208 and automatic gain control (AGC) 210 before being converted to digital signals using the analog-to-digital converter (ADC) 212 and further processed (complex down-conversion and digital baseband) at block 216 to provide pseudoranges.

The AGC 210 is a circuit that can automatically adjust the amplification level of received GNSS signals to maintain an approximately consistent output level for downstream components, compensating for fluctuations in the strength of incoming GNSS signals received at the antenna 202. That is, the AGC 210 can increase gain when signals are weak and decrease gain when signals are strong. As previously noted, AGC values or measurements (e.g., the amount of gain provided by the AGC) can provide information about signals and noise in the RF band. Measurements of AGC values can be used, for example, to detect the introduction of new signals or a change in the noise levels of an RF band. Therefore, AGC values can be potentially used to detect RFI, especially when a GNSS receiver is static and not changing in orientation. However, changes in the orientation can also change AGC values due to the antenna gain pattern.

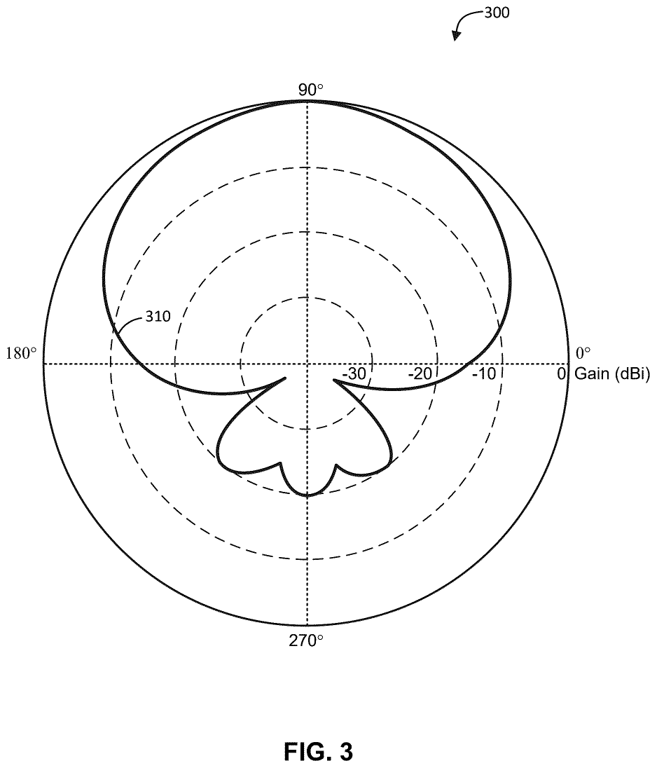

FIG. 3 is a graph 300, which plots antenna gain 310 across azimuth angles for an example antenna. As can be seen in this example, gain is significantly larger at 90° than at other angles, especially in ranges on the lower portion of the graph, such as between 180°-270° and between 270°-0°. Thus, GNSS signals arriving at 90° (relative to the antenna) will experience more gain (less attenuation) than those arriving at other angles. Further, because the antenna is typically fixed to the body of a GNSS device, signals from different sources at different locations will experience different gains for different orientations of the GNSS device.

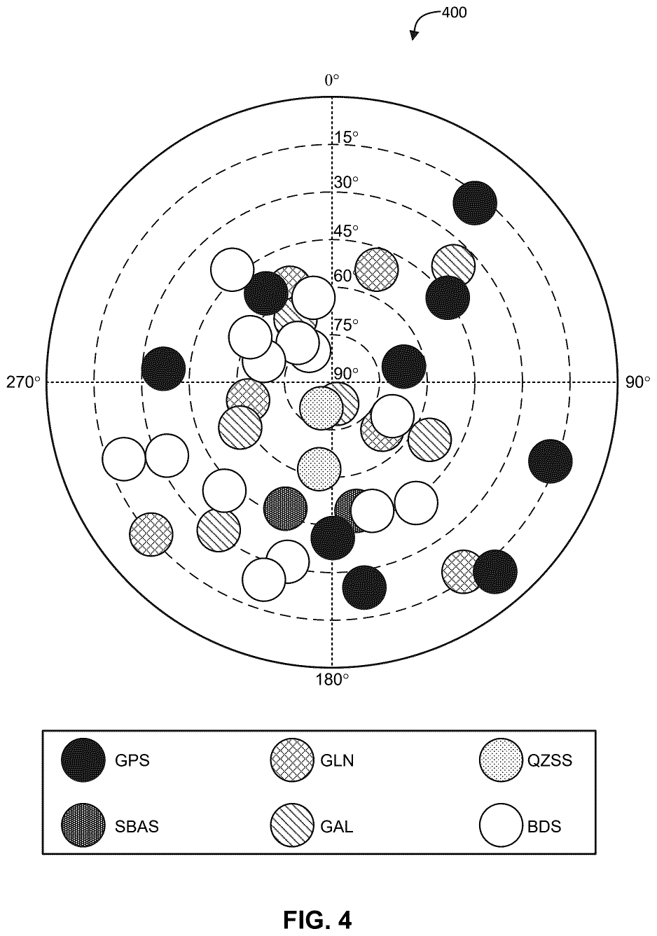

This feature can be leveraged to help detect RFI using AGC. Antenna gain patterns closely resemble the AGC measurements when there is a single signal source or the variation in the line-of-sight vector is minimal, which is the case of most potential RFI. Legitimate GNSS signals (referred to herein as “live sky” data) are often transmitted by multiple satellites in multiple locations (therefore having multiple line-of-sight vectors to the GNSS device. FIG. 4, described below, helps illustrate this point.

FIG. 4 is a skyplot 400 illustrating how GNSS satellites may be spread out spatially from the perspective of a GNSS device, according to an example. The skyplot 400 provides the positions (azimuth and elevation) of GNSS satellites in the sky from a location on the ground (e.g., a location of a GNSS device). As can be seen, many GNSS satellites from various GNSS constellations are visible (satellites from different constellations are shaded differently, as indicated in FIG.). Therefore, in contrast to a single terrestrial RFI source that would experience a single antenna gain in accordance with an antenna gain pattern, multiple satellites transmitting on a single GNSS band (received by the same one or more antennas and experiencing the same AGC) would experience different levels of gain because the antenna receives them at different angles.

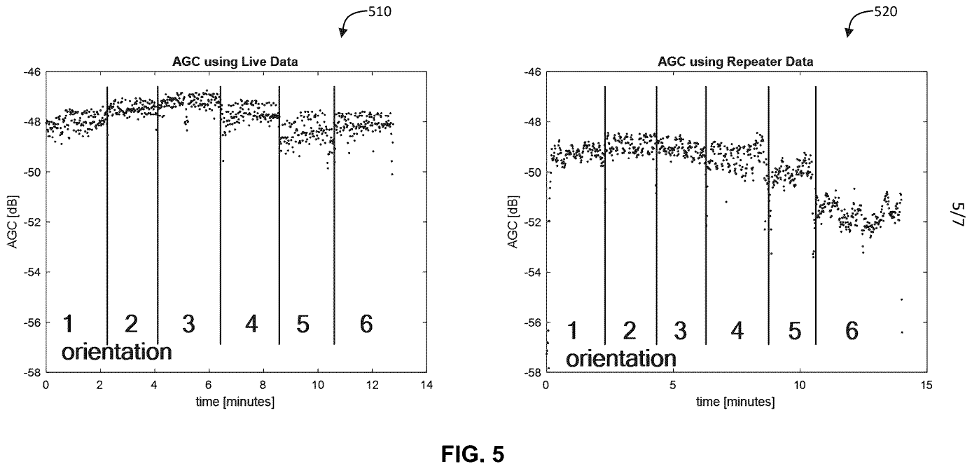

These differences in gains experienced by RFI sources and live sky data may be reflected in differences in AGC values of GNSS signals received by a GNSS device at different orientations. More specifically a change in the GNSS device's orientation for live sky data (without RFI) is likely to lead to smaller variations in AGC values compared to a single terrestrial RFI source. Moreover, variations experienced by a single terrestrial RFI source are more likely to follow the antenna gain pattern. Thus, variations in AGC values that reflect changes in gain due to changes in a GNSS device's orientation, in light of antenna gain pattern, can be different in the presence of RFI. FIG. 5 helps illustrate these differences.

FIG. 5 illustrates graphs 510 and 520 showing experimental results in which AGC values (in decibels) obtained from a GNSS device are plotted over time. During that time, the GNSS device was positioned in six different orientations, as indicated in the graphs 510, 520. In this experiment, the six different orientations are similar to the sides of the cube: four orientations rotated around a vertical axis and separated by 90°. The other two orientations are upward and downward (two orientations rotated around a horizontal axis and separated by) 180°. The first graph 510 illustrates AGC values at the different orientations in a live sky environment with no RFI. The second graph 520 illustrates AGC values in the presence of an RFI source (e.g., a repeater).

As can be seen in FIG. 5, the variation of AGC values in the presence of an RFI source is greater than the variation of AGC values in a live sky environment, due to the fact that signal sources come from multiple directions in the live sky environment. In the first graph 510, representing the live sky environment, AGC values are centered at around −48 dB, ±approximately 1 dB. In orientation 6, AGC values dropped significantly, possibly due to the signals from the RFI source being concentrated around the highest gain region of the antenna. In contrast, in the second graph 520, representing the environment in which RFI is present, AGC values are centered at approximately −51 dB, ±approximately 2 dB. Thus, in this experiment, the variation of AGC values in the presence of RFI is approximately twice that of AGC values in the absence of RFI.

It can be noted that although six different orientations are used in the experiment of FIG. 5, embodiments are not so limited. Embodiments may group “orientations” in a different manner and may have a different number of orientations (e.g., 4, 8, 10, 12, 16, etc.). For example, alternative embodiments may have a larger or smaller number of orientations rotated around a vertical axis and/or rotated around the horizontal axis. Different orientations may comprise, for example, different ranges of elevations combined with different ranges of azimuth angles. (By way of example, six orientations may be defined in which orientations 1-4 may represent orientations in which azimuth angles are 0°-90°, 90°-180°, 180°-270°, and 270°-0°, and elevation angles are between +45°; orientation 5 may represent an orientation in which elevation angle is greater than +45°; and orientation 6 may represent an orientation which elevation angle is less than-45°.) Alternative embodiments may use different ranges and may have any number of orientations. For example, orientations need not be offset by 90°, but may be offset by a larger or smaller angle (e.g., 30°, 45°, 60°, 120°, 180°, etc.). According to some embodiments, the way in which different orientations are determined (e.g., the span or size of the ranges of elevations and azimuth angles) may be based at least in part on a beam width (e.g., −3 dB beam width) of the antenna gain pattern of the GNSS device. Additional or alternative factors may be considered.

Embodiments can leverage the differences in AGC variation for different device orientations to help detect the presence of RFI. Broadly put, embodiments may compute a root mean square (RMS) (or other statistically representative value) for AGC values obtained in each orientation, find the relative variations of RMS with respect to one orientation (find the ratio between the RMS signals), and treat each data as a cluster. The statistical difference between each cluster can be computed to quantify the difference.

Once sufficient AGC data is gathered and processed in this manner, it can be compared with expected AGC values to determine whether it correlates with the antenna gain pattern of the GNSS device. Here, obtaining “sufficient AGC data” can mean obtaining a threshold number of AGC values per orientation (or cluster) for a threshold number of orientations. Examples for determining such a threshold may be N. R. S. Miguel, Y.-H. Chen, S. Lo, T. Walter and D. Akos, “Calibration of RFI Detection Levels in a Low-Cost GNSS Monitor,” 2023 IEEE/ION Position, Location and Navigation Symposium (PLANS), Monterey, CA, USA, 2023, pp. 520-535, doi: 10.1109/PLANS53410.2023.10140085. This may be optimized for different implementations based on antenna patterns, orientation designations, and/or other such factors. In a given situation, this may be dependent on the variation of AGC values between different orientations. In the second graph 520 of FIG. 5, for example, data from orientations 1-4 may not provide the variance in AGC values sufficient to determine that RFI is present. However, data from orientations 2 and 6 may be sufficient, given the difference in AGC values between these two orientations. As such, according to some embodiments, the determination of the absence of RFI (or that RFI is not clearly present) may be made once sufficient AGC data is obtained from all orientations (e.g., to rule out AGC value variations that would indicate the presence of RFI). Moreover, the determination of the presence of RFI may be made once AGC data indicates sufficient variation to suggest the presence of RFI.

Further, the way in which AGC data is obtained may vary depending on the application. According to some embodiments, AGC data may be obtained opportunistically when GNSS measurements are made at different GNSS device orientations. According to some embodiments, GNSS measurements may be triggered upon the detection of the GNSS device being moved to a new orientation to help gather this AGC data. The detection of the orientation of a GNSS device may be based on one or more orientation sensors of the GNSS device (e.g., magnetometer, accelerometer, gyroscope, inertial measurement unit (IMU), etc.). According to some embodiments, if AGC data is insufficient and the GNSS device comprises a mobile phone (or other electronic device that may be relatively easy to reorient), a user may be instructed (e.g., via visible and/or audible instructions through a user interface) to reorient the GNSS device to one or more orientations for which more AGC data is to be obtained, one at a time. Again, one or more orientation sensors of the GNSS device may be used to determine the current orientation and help guide the user to the desired orientation (e.g., using audible and/or visible prompts) to obtain additional AGC data.

Again, embodiments may determine whether RFI is present due to a correlation between variations of AGC values (e.g., RMS values) received at different orientations of the GNSS device with expected variations of AGC values due to the antenna gain pattern of the GNSS device. A correlation between measured AGC values and expected AGC values may be determined, for example, using a correlation coefficient, such as the Pearson correlation coefficient. Additionally, or alternatively, some embodiments may include analyzing relative AGC changes with respect to the lowest, highest, or mean AGC, observed from all orientations. For example, if the reference AGC is the lowest AGC measured from all 6 considered orientations for both the observed and expected measurements, and unit covariance is assumed for both observed and expected AGC measurements, the Pearson correlation coefficient, r, can be found as follows:

$$δ A G {C}_{o b s e r v e d} = A G {C}_{o b s e r v e d} - min ( A G {C}_{o b s e r v e d} ) \qquad ( Eqn . 1 )$$

$$δ {AGC}_{expected} = A G {C}_{expected} - min ( A G {C}_{expected} )$$

$$r = \frac{1}{6} {\sum }_{i = 1}^{6} \sum ( δ A G {C}_{o b s e r v e d}^{i} - δ A G {C}_{expected}^{i} ) .$$

(If a different number of orientations are considered (e.g., 4, 8, 10, 16, etc.), Eqn. 1 could be modified accordingly.) In such embodiments, because relative differenced AGC is used, the absolute AGC level difference due to ambient environment noise will be removed during the correlation coefficient computation. According to some embodiments, a threshold correlation value may be used to determine the presence of RFI (e.g., if the correlation between measured AGC values and expected AGC values exceed or otherwise satisfy the threshold correlation value). The threshold correlation value may be application-specific, balancing factors such as ensuring reliable RFI detection while also minimizing false positives.

It can be noted that the processes above for determining the correlation between obtained AGC values and expected AGC values in view of the antenna gain pattern may be repeated for different GNSS bands. Antennas may have different gain patterns at different frequency bands and/or different antennas may be used for different frequency bands, which can cause differences in expected values for different frequency bands, due to differences in antenna gain patterns. Moreover, different frequency bands may have different sources of RFI. Thus, according to some embodiments, the techniques herein for detecting RFI based on AGC values may be performed on a per-frequency-band basis.

According to some embodiments, RFI detection using AGC values and antenna gain pattern as described above may be complemented by using carrier-to-noise power density (C/No) values, which provide another data source that can help increase the accuracy of RFI detection. In the event of signal attenuation, such as moving the GNSS device into a basement or tunnel, C/No values will decrease, but AGC values will stay the same. In the presence of RFI, however, AGC levels will drop to indicate the introduction of new GNSS signals into the RF band. C/No values, however, may be impacted differently depending on the type of RFI. In the case jamming, C/No values may decrease due to added noise. However, in the case of spoofing, C/No values may stay the same or increase as spoofing signals attempt to overpower the original live signals already present in the RF band. Embodiments may therefore leverage these differences in how AGC and C/No values are impacted to help determine whether RFI is present and, if so, the type of RFI detected by the GNSS device.

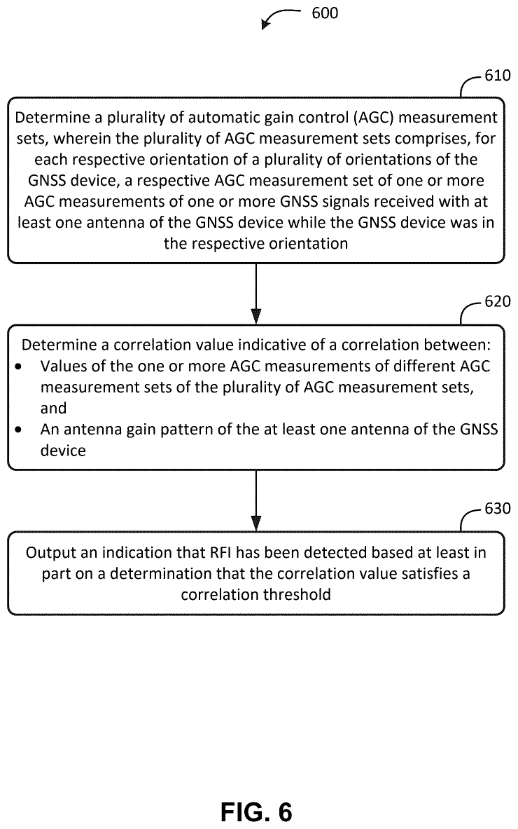

Triggers for performing RFI detection using the techniques described herein may vary, depending on desired functionality. For example, geofencing is one way in which RFI detection may be triggered. Areas known to be subject to RFI may be identified, and RFI detection may be performed by a GNSS device when the GNSS device enters the area (e.g., as determined using GNSS and/or another positioning technique). Additionally, or alternatively, RFI detection may be triggered when GNSS-based position estimates do not match position estimates obtained from other positioning techniques, such as radio access technology (RAT)-based positioning using a cellular and/or Wi-Fi network. GNSS signal power may be an additional or alternative trigger for RFI detection. Sudden increases in received signal power and/or signal power increasing above a normal range (e.g., >50 dB-Hz) may be due to RFI, and thus may be used as a trigger for RFI detection using the RFI detection techniques described herein. An example method of performing RFI detection, according to some embodiments, is shown in FIG. 6, described below.

FIG. 6 is a flow diagram of a method 600 of RFI detection by a GNSS device, according to an embodiment. Aspects of the method 600 may correspond to aspects of embodiments described previously. Means and/or structure for performing the functionality illustrated in one or more of the blocks shown in FIG. 6 may be performed by hardware and/or software components of a GNSS device. Example components of a GNSS device 700 are illustrated in FIG. 7, which is described in more detail below. According to some embodiments, the GNSS device may comprise a mobile phone or a vehicle.

At block 610, the functionality comprises determining a plurality of automatic gain control (AGC) measurement sets, wherein the plurality of AGC measurement sets comprises, for each respective orientation of a plurality of orientations of the GNSS device, a respective AGC measurement set of one or more AGC measurements of one or more GNSS signals received with at least one antenna of the GNSS device while the GNSS device was in the respective orientation. As previously noted herein, this may mean that a threshold number of AGC measurements (e.g., values) for each AGC measurement set (e.g., cluster) of a threshold number of orientations. The threshold number of AGC measurements may vary (e.g., 1, 5, 10, 25, 50, 100, etc.), and/or the threshold number of orientations (e.g., 2, 4, 6, etc.), which may vary based on application, accuracy requirements, and/or other factors. As noted elsewhere herein, determining the plurality AGC measurement sets may comprise instructing a user of the GNSS device, e.g., via a user interface of the GNSS device, to reorient the GNSS device to one or more of the plurality of orientations. According to some embodiments, instructing a user of the GNSS device to reorient the GNSS device may be responsive to a determination that an initial set of orientations corresponding to an initial set of AGC measurement sets does not meet a threshold number of orientations. Thus, according to some embodiments, the determining at block 610 may include an iterative process of obtaining AGC measurements.

Means for performing functionality at block 610 may comprise at least one bus 705, processor 710, digital signal processor 720, wireless communication interface 730, memory 760, GNSS receiver 780, antenna 782, and/or other components of a GNSS device 700, as illustrated in FIG. 7.

At block 620, the functionality comprises determining a correlation value indicative of a correlation between: values of the one or more AGC measurements of different AGC measurement sets of the plurality of AGC measurement sets, and an antenna gain pattern of the at least one antenna of the GNSS device. As noted in the embodiments described previously, determining the correlation value may comprise determining a respective root mean square (RMS) value for each AGC measurement set of the plurality of AGC measurement sets. Additionally or alternatively, as noted, a correlation value may comprise a correlation coefficient, such as a Pearson correlation coefficient. According to some embodiments, this also may be used to determine a threshold correlation value, which may be a predetermined value, or may be determined dynamically.

Means for performing functionality at block 620 may comprise at least one bus 705, processor 710, digital signal processor 720, memory 760, GNSS receiver 780, and/or other components of a GNSS device 700, as illustrated in FIG. 7.

At block 630, the functionality comprises outputting an indication that RFI has been detected based at least in part on a determination that the correlation value satisfies a correlation threshold. According to some embodiments, outputting the indication that RFI has been detected may be further based at least in part on a variance of carrier-to-noise power density (C/No) values satisfying a threshold, wherein the C/No values may correspond to one or more GNSS signals received with the at least one antenna of the GNSS device while the GNSS device was in each orientation of the plurality of orientations. Additionally, or alternatively, outputting the indication that RFI has been detected may comprise sending the indication to an operating system or application executed by the GNSS device, sending the indication to an application processor of the GNSS device, sending the indication from the GNSS device to a device separate from the GNSS device, outputting the indication at a user interface of the GNSS device, or any combination thereof.

Means for performing functionality at block 630 may comprise at least one bus 705, processor 710, digital signal processor 720, wireless communication interface 730, memory 760, GNSS receiver 780, antenna 782, and/or other components of a GNSS device 700, as illustrated in FIG. 7.

FIG. 7 is a block diagram of an embodiment of a GNSS device 700, which can be utilized as described herein above (e.g., in association with FIGS. 1-6). In some embodiments, GNSS device 700 may perform one or all of the functions of the method 600 of FIG. 6. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations (and in which case a GNSS position may be determined for the GNSS receiver 780). Furthermore, the GNSS device 700 may be incorporated into another device, such as a cell phone, vehicle, etc., as previously noted.

The GNSS device 700 is shown comprising hardware elements that can be electrically coupled via a bus 705 (or may otherwise be in communication, as appropriate). The hardware elements may include a processor(s) 710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on desired functionality. Location determination and/or other determinations based on wireless communication may be provided in the processor(s) 710 and/or wireless communication interface 730 (discussed below). The GNSS device 700 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The GNSS device 700 may also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 700 to communicate with other devices as described in the embodiments above. The wireless communication interface 730 may permit data and signaling to be communicated (e.g., transmitted and received) with base stations of a wireless network (e.g. a cellular network), for example, via eNBs, gNBs, ng-eNBs, access points, and/or other access node types, and/or other network components, computer systems, and/or any other electronic devices communicatively coupled with base stations. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques, with respective digital and/or analog circuitry. The wireless communication interface 730 may include such circuitry.

Depending on desired functionality, the wireless communication interface 730 may comprise a separate receiver and transmitter, or any combination of transceivers, transmitters, and/or receivers to communicate with base stations (e.g., ng-eNBs and gNBs) and/or other terrestrial transceivers, such as wireless devices and access points. The GNSS device 700 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), inertial measurement unit(s) (IMU(s)), or the like), some of which may be used to obtain position-related measurements and/or other information.

Embodiments of the GNSS device 700 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the GNSS device 700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 710 or DSP 720.

The GNSS device 700 may further include and/or be in communication with a memory 760. The memory 760 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the GNSS device 700 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the GNSS device 700 (and/or processor(s) 710 or DSP 720 within GNSS device 700). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of radio frequency interference (RFI) detection by a global navigation satellite system (GNSS) device, the method comprising: determining a plurality of automatic gain control (AGC) measurement sets, wherein the plurality of AGC measurement sets comprises, for each respective orientation of a plurality of orientations of the GNSS device, a respective AGC measurement set of one or more automatic gain control (AGC) measurements of one or more GNSS signals received with at least one antenna of the GNSS device while the GNSS device was in the respective orientation; determining a correlation value indicative of a correlation between: values of the one or more AGC measurements of different AGC measurement sets of the plurality of AGC measurement sets, and an antenna gain pattern of the at least one antenna of the GNSS device; and outputting an indication that RFI has been detected based at least in part on a determination that the correlation value satisfies a correlation threshold.

Clause 2: The method of clause 1, wherein outputting the indication that RFI has been detected is further based at least in part on a variance of carrier-to-noise power density (C/No) values satisfying a threshold, wherein the C/No values correspond to one or more GNSS signals received with the at least one antenna of the GNSS device while the GNSS device was in each orientation of the plurality of orientations.

Clause 3: The method of either of clauses 1 or 2, wherein determining the plurality AGC measurement sets comprises instructing a user of the GNSS device, via a user interface of the GNSS device, to reorient the GNSS device to one or more of the plurality of orientations.

Clause 4: The method of clause 3, wherein instructing a user of the GNSS device to reorient the GNSS device is responsive to a determination that an initial set of orientations corresponding to an initial set of AGC measurement sets does not meet a threshold number of orientations.

Clause 5: The method of any one of clauses 1-4, wherein determining the correlation value comprises determining a respective root mean square (RMS) value for each AGC measurement set of the plurality of AGC measurement sets.

Clause 6: The method of any one of clauses 1-5, wherein the GNSS device comprises a mobile phone or a vehicle.

Clause 7: The method of any one of clauses 1-6, wherein outputting the indication that RFI has been detected comprises: sending the indication to an operating system or application executed by the GNSS device; sending the indication to an application processor of the GNSS device; sending the indication from the GNSS device to a device separate from the GNSS device; outputting the indication at a user interface of the GNSS device; or any combination thereof.

Clause 8: A global navigation satellite system global navigation satellite system (GNSS) device comprising: at least one antenna, at least one GNSS receiver, at least one processor communicatively coupled with the at least one antenna and at least one GNSS receiver, the at least one processor configured to: determine a plurality of automatic gain control (AGC) measurement sets, wherein the plurality of AGC measurement sets comprises, for each respective orientation of a plurality of orientations of the GNSS device, a respective AGC measurement set of one or more automatic gain control (AGC) measurements of one or more GNSS signals received with at least one antenna of the GNSS device while the GNSS device was in the respective orientation; determine a correlation value indicative of a correlation between: values of the one or more AGC measurements of different AGC measurement sets of the plurality of AGC measurement sets, and an antenna gain pattern of the at least one antenna of the GNSS device; and output an indication that radio frequency interference (RFI) has been detected based at least in part on a determination that the correlation value satisfies a correlation threshold.

Clause 9: The GNSS device of clause 8, wherein the at least one processor is configured to output the indication that RFI has been detected further based at least in part on a variance of carrier-to-noise power density (C/No) values satisfying a threshold, wherein the C/No values correspond to one or more GNSS signals received with the at least one antenna of the GNSS device while the GNSS device was in each orientation of the plurality of orientations.

Clause 10: The GNSS device of either of clauses 8 or 9, further comprising at least one user interface, wherein, to determine the plurality AGC measurement sets, the at least one processor is configured to instruct a user of the GNSS device, via the at least one user interface, to reorient the GNSS device to one or more of the plurality of orientations.

Clause 11: The GNSS device of clause 10, wherein the at least one processor is configured to instruct a user of the GNSS device to reorient the GNSS device responsive to a determination that an initial set of orientations corresponding to an initial set of AGC measurement sets does not meet a threshold number of orientations.

Clause 12: The GNSS device of any one of clauses 8-11, wherein, to determine the correlation value, the at least one processor is configured to determine a respective root mean square (RMS) value for each AGC measurement set of the plurality of AGC measurement sets.

Clause 13: The GNSS device of any one of clauses 8-12, wherein the GNSS device comprises a mobile phone or a vehicle.

Clause 14: The GNSS device of any one of clauses 8-13, wherein, to output the indication that RFI has been detected, the at least one processor is configured to: send the indication to an operating system or application executed by the GNSS device; send the indication to an application processor of the GNSS device; send the indication from the GNSS device to a device separate from the GNSS device; output the indication at a user interface of the GNSS device; or any combination thereof.

Clause 15: An apparatus comprising: means for determining a plurality of automatic gain control (AGC) measurement sets, wherein the plurality of AGC measurement sets comprises, for each respective orientation of a plurality of orientations of the apparatus, a respective AGC measurement set of one or more automatic gain control (AGC) measurements of one or more global navigation satellite system global navigation satellite system (GNSS) signals received with at least one antenna of the apparatus while the apparatus was in the respective orientation; means for determining a correlation value indicative of a correlation between: values of the one or more AGC measurements of different AGC measurement sets of the plurality of AGC measurement sets, and an antenna gain pattern of the at least one antenna of the apparatus; and means for outputting an indication that RFI has been detected based at least in part on a determination that the correlation value satisfies a correlation threshold.

Clause 16: The apparatus of clause 15, wherein the means for outputting the indication that RFI has been detected is configured to output the indication further base at least in part on a variance of carrier-to-noise power density (C/No) values satisfying a threshold, wherein the C/No values correspond to one or more GNSS signals received with the at least one antenna of the apparatus while the apparatus was in each orientation of the plurality of orientations.

Clause 17: The apparatus of either of clauses 15 or 16, wherein the means for determining the plurality AGC measurement sets comprises means for instructing a user of the apparatus, via a user interface of the apparatus, to reorient the apparatus to one or more of the plurality of orientations.

Clause 18: The apparatus of clause 17, wherein the means for instructing a user of the apparatus to reorient the apparatus is configured to instruct the user of the apparatus to reorient the apparatus responsive to a determination that an initial set of orientations corresponding to an initial set of AGC measurement sets does not meet a threshold number of orientations.

Clause 19: The apparatus of any one of clauses 15-18, wherein the means for determining the correlation value comprises means for determining a respective root mean square (RMS) value for each AGC measurement set of the plurality of AGC measurement sets.

Clause 20: The apparatus of any one of clauses 15-19, wherein the apparatus comprises a mobile phone or a vehicle.

Clause 21: A non-transitory computer-readable medium storing instructions, the instructions comprising code for performing the method of any one of clauses 1-7.

What is claimed is:

1. A method of radio frequency interference (RFI) detection by a global navigation satellite system (GNSS) device, the method comprising:
determining a plurality of automatic gain control (AGC) measurement sets, wherein the plurality of AGC measurement sets comprises, for each respective orientation of a plurality of orientations of the GNSS device, a respective AGC measurement set of one or more AGC measurements of one or more GNSS signals received with at least one antenna of the GNSS device while the GNSS device was in the respective orientation;
determining a correlation value indicative of a correlation between:
values of the one or more AGC measurements of different AGC measurement sets of the plurality of AGC measurement sets, and
an antenna gain pattern of the at least one antenna of the GNSS device; and
outputting an indication that RFI has been detected based at least in part on a determination that the correlation value satisfies a correlation threshold.

2. The method of claim 1, wherein outputting the indication that RFI has been detected is further based at least in part on a variance of carrier-to-noise power density (C/No) values satisfying a threshold, wherein the C/No values correspond to one or more GNSS signals received with the at least one antenna of the GNSS device while the GNSS device was in each orientation of the plurality of orientations.

3. The method of claim 1, wherein determining the plurality AGC measurement sets comprises instructing a user of the GNSS device, via a user interface of the GNSS device, to reorient the GNSS device to one or more of the plurality of orientations.

4. The method of claim 3, wherein instructing a user of the GNSS device to reorient the GNSS device is responsive to a determination that an initial set of orientations corresponding to an initial set of AGC measurement sets does not meet a threshold number of orientations.

5. The method of claim 1, wherein determining the correlation value comprises determining a respective root mean square (RMS) value for each AGC measurement set of the plurality of AGC measurement sets.

6. The method of claim 1, wherein the GNSS device comprises a mobile phone or a vehicle.

7. The method of claim 1, wherein outputting the indication that RFI has been detected comprises:
sending the indication to an operating system or application executed by the GNSS device;
sending the indication to an application processor of the GNSS device;
sending the indication from the GNSS device to a device separate from the GNSS device;
outputting the indication at a user interface of the GNSS device; or
any combination thereof.

8. A global navigation satellite system global navigation satellite system (GNSS) device comprising:
at least one antenna;
at least one GNSS receiver; and
at least one processor communicatively coupled with the at least one antenna and at least one GNSS receiver, the at least one processor configured to:
determine a plurality of automatic gain control (AGC) measurement sets, wherein the plurality of AGC measurement sets comprises, for each respective orientation of a plurality of orientations of the GNSS device, a respective AGC measurement set of one or more AGC measurements of one or more GNSS signals received with at least one antenna of the GNSS device while the GNSS device was in the respective orientation;
determine a correlation value indicative of a correlation between:
values of the one or more AGC measurements of different AGC measurement sets of the plurality of AGC measurement sets, and
an antenna gain pattern of the at least one antenna of the GNSS device; and
output an indication that radio frequency interference (RFI) has been detected based at least in part on a determination that the correlation value satisfies a correlation threshold.

9. The GNSS device of claim 8, wherein the at least one processor is configured to output the indication that RFI has been detected further based at least in part on a variance of carrier-to-noise power density (C/No) values satisfying a threshold, wherein the C/No values correspond to one or more GNSS signals received with the at least one antenna of the GNSS device while the GNSS device was in each orientation of the plurality of orientations.

10. The GNSS device of claim 8, further comprising at least one user interface, wherein, to determine the plurality AGC measurement sets, the at least one processor is configured to instruct a user of the GNSS device, via the at least one user interface, to reorient the GNSS device to one or more of the plurality of orientations.

11. The GNSS device of claim 10, wherein the at least one processor is configured to instruct a user of the GNSS device to reorient the GNSS device responsive to a determination that an initial set of orientations corresponding to an initial set of AGC measurement sets does not meet a threshold number of orientations.

12. The GNSS device of claim 8, wherein, to determine the correlation value, the at least one processor is configured to determine a respective root mean square (RMS) value for each AGC measurement set of the plurality of AGC measurement sets.

13. The GNSS device of claim 8, wherein the GNSS device comprises a mobile phone or a vehicle.

14. The GNSS device of claim 8, wherein, to output the indication that RFI has been detected, the at least one processor is configured to:
send the indication to an operating system or application executed by the GNSS device;
send the indication to an application processor of the GNSS device;
send the indication from the GNSS device to a device separate from the GNSS device;
output the indication at a user interface of the GNSS device; or
any combination thereof.

15. An apparatus comprising:
means for determining a plurality of automatic gain control (AGC) measurement sets, wherein the plurality of AGC measurement sets comprises, for each respective orientation of a plurality of orientations of the apparatus, a respective AGC measurement set of one or more AGC measurements of one or more global navigation satellite system global navigation satellite system (GNSS) signals received with at least one antenna of the apparatus while the apparatus was in the respective orientation;
means for determining a correlation value indicative of a correlation between:
values of the one or more AGC measurements of different AGC measurement sets of the plurality of AGC measurement sets, and
an antenna gain pattern of the at least one antenna of the apparatus; and
means for outputting an indication that RFI has been detected based at least in part on a determination that the correlation value satisfies a correlation threshold.

16. The apparatus of claim 15, wherein the means for outputting the indication that RFI has been detected is configured to output the indication further base at least in part on a variance of carrier-to-noise power density (C/No) values satisfying a threshold, wherein the C/No values correspond to one or more GNSS signals received with the at least one antenna of the apparatus while the apparatus was in each orientation of the plurality of orientations.

17. The apparatus of claim 15, wherein the means for determining the plurality AGC measurement sets comprises means for instructing a user of the apparatus, via a user interface of the apparatus, to reorient the apparatus to one or more of the plurality of orientations.

18. The apparatus of claim 17, wherein the means for instructing a user of the apparatus to reorient the apparatus is configured to instruct the user of the apparatus to reorient the apparatus responsive to a determination that an initial set of orientations corresponding to an initial set of AGC measurement sets does not meet a threshold number of orientations.

19. The apparatus of claim 15, wherein the means for determining the correlation value comprises means for determining a respective root mean square (RMS) value for each AGC measurement set of the plurality of AGC measurement sets.

20. The apparatus of claim 15, wherein the apparatus comprises a mobile phone or a vehicle.
